(19) United States
(12) Patent Application Publication
(10) Pub. No.: US 2018/0293923 A1
(43) Pub. Date: Oct. 11, 2018

(54) DISPLAY PANEL AND DISPLAY DEVICE

(71) Applicant: Shenzhen China Star Optoelectronics Technology Co., Ltd., Shenzhen, Guangdong (CN)

(72) Inventors: Longqiang SHI, Shenzhen, Guangdong (CN); SHU-JHIH CHEN, Shenzhen, Guangdong (CN)

(73) Assignee: Shenzhen China Star Optoelectronics Technology Co. , Ltd., Shenzhen, Guangdong (CN)

(21) Appl. No.: 15/540,963

(22) PCT Filed: May 10, 2017
(86) PCT No.: PCT/CN2017/083685

§ 371 Date: Jun. 29, 2017

(30) Foreign Application Priority Data
Apr. 10, 2017 (CN) 201710229073.1

(51) Int. Cl. G09G 3/20

(52) U.S. Cl. CPC G09G 3/20; G09G 2310/06; G09G 2310/0205; G09G 2320/0223

(57) ABSTRACT

A display panel and a display device are disclosed. The display panel includes a first control signal unit for outputting multiple first control signals; a second control signal unit for outputting multiple second control signals, wherein the multiple first control signals and the multiple second control signals are the same; and a first scanning driving circuit connected with the first control signal unit and the second control signal unit, and used for receiving the multiple first control signals from the first control signal unit, receiving the multiple second control signals from the second control signal unit and outputting a first scanning signal in order to reduce the RC load, avoid the abnormality of the waveform of the output scanning signal so as to improve the display quality.

### BACKGROUND OF THE INVENTION

### 1. Field of the Invention

The present invention relates to a display technology field, and more particularly to a display panel and a display device.

### 2. Description of Related Art

For a large-size, high-resolution, high-frequency display panel such as a 85 in/8K/4K/120 Hz display panel. The RC load of the scanning line and the data line will be great such that the output scanning signal seriously loss in the transmission process in order to affect the display quality. Currently, a GOA (Gate Driver on Array) technology is beneficial to a narrow-frame design and cost decreasing of the display panel so that the GOA technology has been widely applied and researched. For the display panel having the GOA circuit, the RC load is not only on the scanning line and the data line, but also on the control signals CK, XCK, VSS and STV for driving the GOA circuit. The above signals will affect the waveforms of the output scanning signal so as to decrease the display quality.

### SUMMARY OF THE INVENTION

The technology problem mainly solved by the present invention is to provide a display panel and a display device in order to solve the affection of the output scanning signal generated by the RC load of the control signals in order to improve the display quality.

In order to solve the above technology problem, a technology solution adopted by the present invention is: providing a display panel, comprising: a first control signal unit for outputting multiple first control signals; a second control signal unit for outputting multiple second control signals, wherein the multiple first control signals and the multiple second control signals are the same; a first scanning driving circuit connected with the first control signal unit and the second control signal unit, and used for receiving the multiple first control signals from the first control signal unit, receiving the multiple second control signals from the second control signal unit and outputting a first scanning signal; a second scanning driving circuit is connected with the first control signal unit and the second control signal unit, and used for receiving the multiple first control signals from the first control signal unit, receiving the multiple second control signals from the second control signal unit and outputting a second scanning signal, wherein, the first scanning driving circuit and the second scanning driving circuit simultaneously output the first scanning signal and the second scanning signal according to the multiple first control signals and the multiple second control signals received from the first control signal unit and the second control signal unit; and wherein, each of the first control signal unit and the second control signal unit includes a circuit board and a control chip located on the circuit board for generating the multiple first control signals or the multiple second control signals.

In order solve the above technology problem, a technology solution adopted by the present invention is: providing a display panel, comprising: a first control signal unit for outputting multiple first control signals; a second control signal unit for outputting multiple second control signals, wherein the multiple first control signals and the multiple second control signals are the same; and a first scanning driving circuit connected with the first control signal unit and the second control signal unit, and used for receiving the multiple first control signals from the first control signal unit, receiving the multiple second control signals from the second control signal unit and outputting a first scanning signal.

In order to solve the above technology problem, another technology solution adopted by the present invention is: a display device, wherein, the display device includes a display panel, and the display panel comprises: a first control signal unit for outputting multiple first control signals; a second control signal unit for outputting multiple second control signals, wherein the multiple first control signals and the multiple second control signals are the same; and a first scanning driving circuit connected with the first control signal unit and the second control signal unit, and used for receiving the multiple first control signals from the first control signal unit, receiving the multiple second control signals from the second control signal unit and outputting a first scanning signal. The beneficial effect of the present invention is: comparing to the conventional art, through disposing the first control signal unit and the second control signal unit, the scanning driving circuit can receives same first control signals and second control signals simultaneously from the first control signal unit and the second control signal unit in order to reduce the RC load, avoid the abnormality of the waveform of the output scanning signal so as to improve the display quality.

### BRIEF DESCRIPTION OF THE DRAWINGS

FIG. 1 is a schematic diagram of a display panel of the conventional art;

FIG. 2 is a schematic diagram of a single-side driving of a scanning driving circuit in FIG. 1;

FIG. 3 is a schematic diagram of a first embodiment of the display panel of the present invention

FIG. 4 is a schematic diagram of a second embodiment of the display panel of the present invention;

FIG. 5 is a schematic circuit diagram of the display panel shown in FIG. 4;

FIG. 6 is a schematic diagram of a double-side driving of the scanning driving circuit shown in FIG. 4;

FIG. 7 is a schematic comparison diagram of output scanning signals of a conventional display panel and the display panel of the present invention; and

FIG. 8 is a schematic diagram of a display device of the present invention.

### DETAILED DESCRIPTION OF THE PREFERRED EMBODIMENT

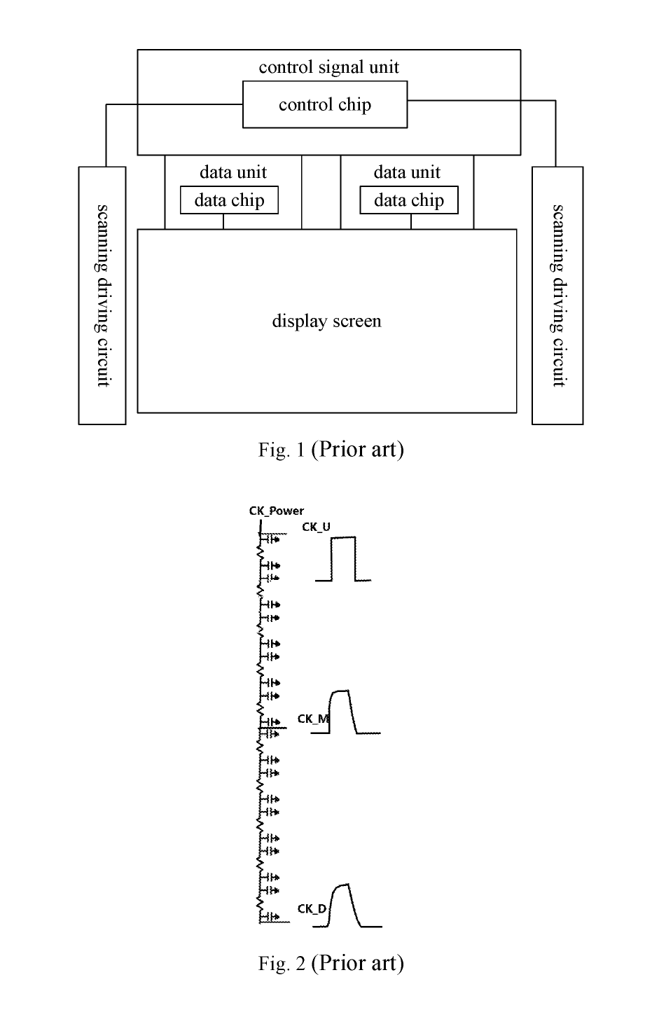

With reference to FIG. 1 and FIG. 2, which are a schematic diagram of a display panel and a schematic diagram of a single-side driving of a scanning driving circuit of a display panel of the conventional art. In FIG. 1, the scanning driving circuits at two sides of the display panel only receive control signals from a same signal control unit at a same side. That is, the control signals received by each scanning driving circuit from the control signal unit adopt a single-side driving method. In FIG. 2, an operation principle of adopting the single-side driving method of a control signal CK is used for illustrating. As shown in FIG. 2, when the control signal CK is delivered from a top to a bottom, a waveform of the control signal at the upper terminal CK_U is slightly affected, which is close to an ideal square wave. When the control signal CK is delivered to lower stages, the RC load will be greater, and the waveform of the control signal at the middle CK_M is affected, the waveform of the control signal at the lower terminal CK_D is worse and worse such that the waveform of the output scanning signal is worse so that the display quality is decreased.

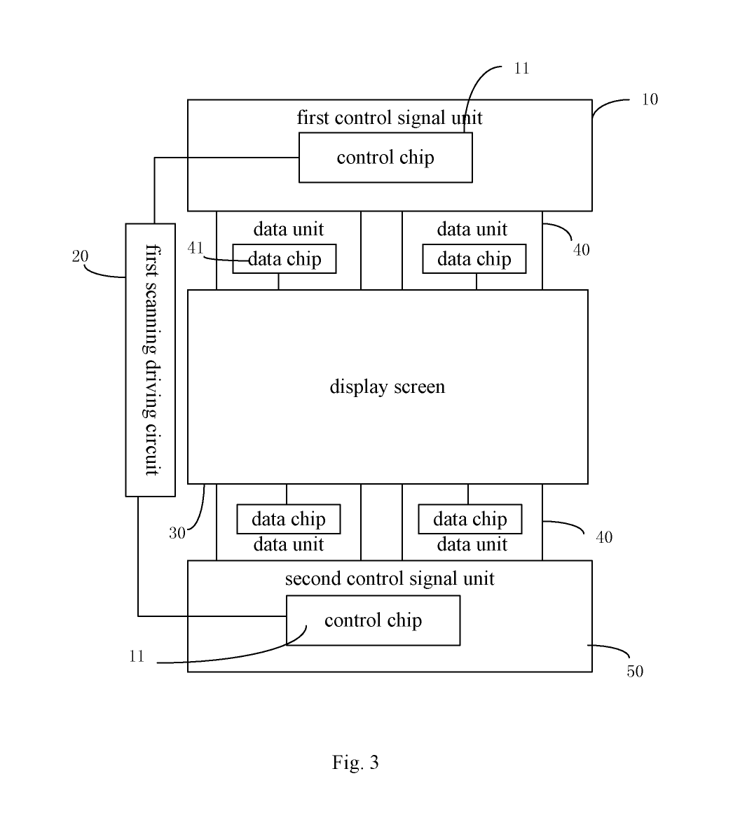

With reference to FIG. 3, which is a schematic diagram of a first embodiment of the display panel of the present invention. The display panel 1 includes a first control signal unit 10 for outputting multiple first control signals; a second control signal unit 50 for outputting multiple second control signals. The multiple first control signals and the multiple second control signals are the same. The first scanning driving circuit 20 is connected with the first control signal unit 10 and the second control signal unit 50 for receiving the multiple first control signals from the first control signal unit 10, receiving the multiple second control signals from the second control signal unit 50 and outputting a first scanning signal.

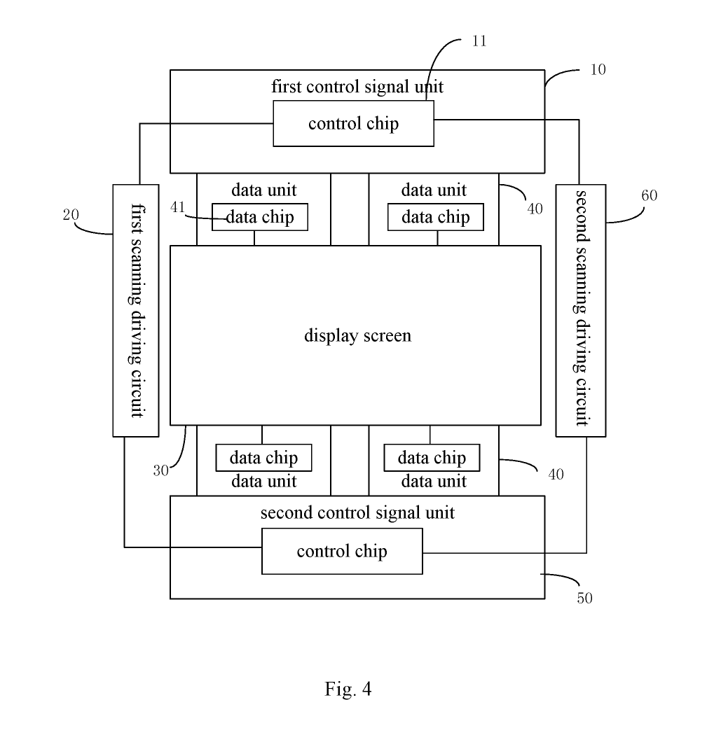

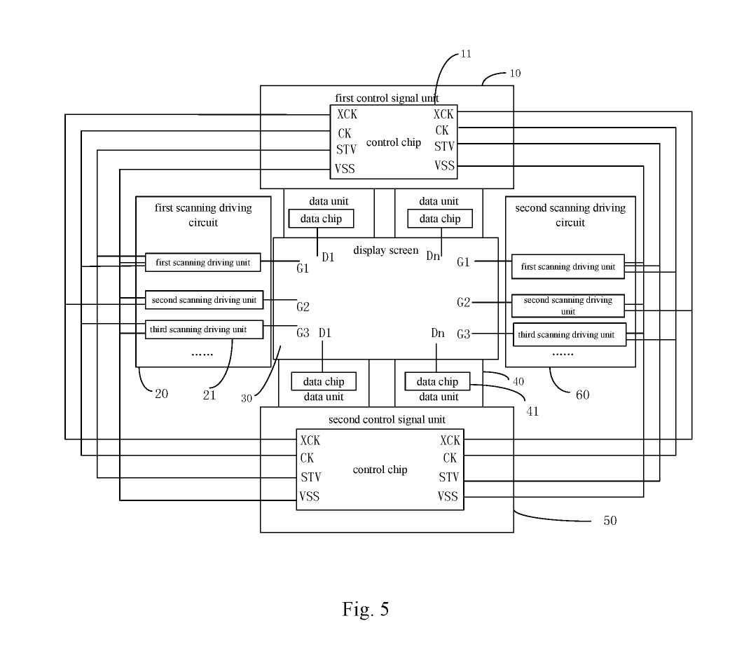

With reference to FIG. 4 and FIG. 5, which is a schematic diagram of a second embodiment of the display panel of the present invention. The difference between the second embodiment and the above first embodiment is: the display panel 1 further includes a second scanning driving circuit 60. The second scanning driving circuit 60 is connected with the first control signal unit 10 and the second control signal unit 50, and used for receiving the multiple first control signals from the first control signal unit 10, receiving the multiple second control signals from the second control signal unit 50 and outputting a second scanning signal. Wherein, the first scanning driving circuit 20 and the second scanning driving circuit 60 simultaneously output the first scanning signal and the second scanning signal according to the first control signals and the second control signals received from the first control signal unit 10 and the second control signal unit 50.

Specifically, each of the first control signals and the second control signals includes a first clock signal CK, a second clock signal XCK opposite to the first clock signal in phase, a driving signal STV and a ground signal VSS. Each of the first scanning driving circuit 20 and the second scanning driving circuit 60 includes multiple scanning driving units connected sequentially such as a first scanning driving unit, a second scanning driving unit connected with the first scanning driving unit, a third scanning driving unit connected with the second scanning driving unit and so on. Each scanning driving unit is used for outputting a corresponding scanning signal. For example, the first scanning driving unit outputs a scanning signal G1, the second scanning driving unit outputs a scanning signal G2, and the third scanning driving unit outputs a scanning signal G3. Wherein, the driving signal STV is inputted to the first scanning driving unit, the first clock signal CK is inputted to an odd-numbered scanning driving unit, the second clock signal XCK is inputted to the even-numbered scanning driving unit, and the ground signal VSS is inputted to each scanning driving unit.

Wherein, the display panel 1 further includes a display screen 30. The first control signal unit 10 is located directly above the display screen 30, the second control signal unit 50 is located directly below the display screen 30. The first scanning driving circuit 20 is located at a left side of the display screen 30, the second scanning driving circuit 60 is located at a right side of the display screen 30. The first scanning driving circuit 20 and the second scanning driving circuit 60 simultaneously provides the first scanning signal and the second scanning signal to the display screen 30.

Wherein, the display panel 1 further includes four data units 40, each data unit 40 includes a circuit board and a data chip 41 located on the circuit board for generating a data signal. Wherein, two data units 40 are located between the display screen 30 and the first control signal unit 10 for providing data signals D1 to Dn to the display screen 30. The other two data units 40 are located between the display screen 30 and the second control signal unit 50 for providing data signals D1 to Dn to the display screen 30.

Wherein, each of the first control signal unit 10 and the second control signal unit 50 includes a circuit board and a control chip 11 located on the circuit board for generating the multiple first control signals or the multiple second control signals.

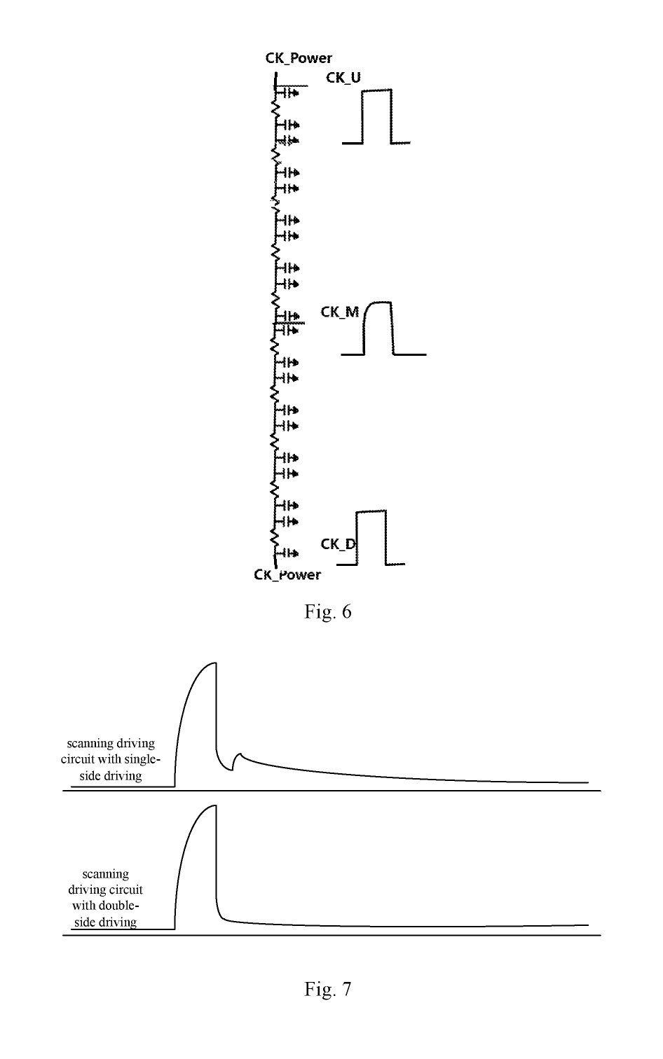

With reference to FIG. 6, which is a schematic diagram of a double-side driving of the scanning driving circuit of the display panel 1. Wherein, each of the first scanning driving circuit 20 and the second scanning driving circuit 60 adopts a double-side driving method. Accordingly, a load of the control signal is halved in order to improve the waveform of the control signal. Then, finally, an ideal output waveform of the scanning signal is obtained. The following will adopt a double-side driving of the control signal CK for illustrating. The waveform of the first clock signal CK is delivered from two terminals to a center. The waveforms of the control signal at the upper terminal CK_U and the lower terminal CK_D are slightly affected by RC load, which are ideal square waves. Along with the transmitting of the first clock signal CK toward the center, the RC load becomes greater and greater such that the waveform of the control signal at the center CK_M become worse. However, the double-side driving method can make the RC load to be halved, and since the RC load is halved, the waveform of the control signal at the center CK_M is greatly improved.

With reference to FIG. 7, which is a schematic comparison diagram of output scanning signals of a conventional display panel and the display panel of the present invention. As shown in FIG. 7, the waveform of the output scanning signal of the single-side driving method of the scanning driving circuit of the conventional display panel has a peak pulse at a shoulder portion, and the waveform of the double-side driving method of the scanning driving circuit of the display panel of the present invention is normal.

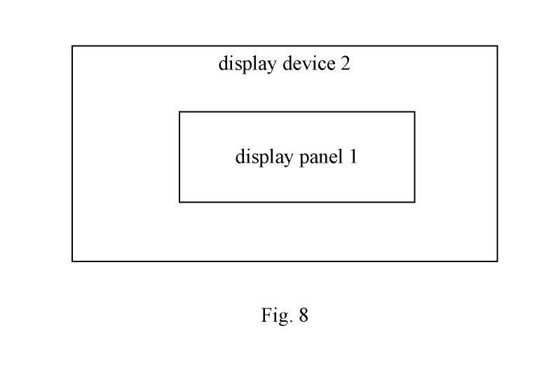

With reference to FIG. 8, which is a schematic diagram of a display device 2 of the present invention. The display device 2 includes a display panel 1 described above. The other devices and functions of the display device are the same as the devices and functions of the conventional display device, no more repeating.

The display panel and the display device, through disposing the first control signal unit and the second control signal unit, the scanning driving circuit can receives same first control signals and second control signals simultaneously from the first control signal unit and the second control signal unit in order to reduce the RC load, avoid the abnormality of the waveform of the output scanning signal so as to improve the display quality.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A display panel, comprising:
a first control signal unit for outputting multiple first control signals;
a second control signal unit for outputting multiple second control signals, wherein the multiple first control signals and the multiple second control signals are the same;
a first scanning driving circuit connected with the first control signal unit and the second control signal unit, and used for receiving the multiple first control signals from the first control signal unit, receiving the multiple second control signals from the second control signal unit and outputting a first scanning signal;
a second scanning driving circuit is connected with the first control signal unit and the second control signal unit, and used for receiving the multiple first control signals from the first control signal unit, receiving the multiple second control signals from the second control signal unit and outputting a second scanning signal, wherein, the first scanning driving circuit and the second scanning driving circuit simultaneously output the first scanning signal and the second scanning signal according to the multiple first control signals and the multiple second control signals received from the first control signal unit and the second control signal unit; and
wherein, each of the first control signal unit and the second control signal unit includes a circuit board and a control chip located on the circuit board for generating the multiple first control signals or the multiple second control signals.

2. A display panel, comprising:
a first control signal unit for outputting multiple first control signals;
a second control signal unit for outputting multiple second control signals, wherein the multiple first control signals and the multiple second control signals are the same; and
a first scanning driving circuit connected with the first control signal unit and the second control signal unit, and used for receiving the multiple first control signals from the first control signal unit, receiving the multiple second control signals from the second control signal unit and outputting a first scanning signal.

3. The display panel according to claim 2, wherein, the display panel further includes a second scanning driving circuit is connected with the first control signal unit and the second control signal unit, and used for receiving the multiple first control signals from the first control signal unit, receiving the multiple second control signals from the second control signal unit and outputting a second scanning signal, wherein, the first scanning driving circuit and the second scanning driving circuit simultaneously output the first scanning signal and the second scanning signal according to the multiple first control signals and the multiple second control signals received from the first control signal unit and the second control signal unit.

4. The display panel according to claim 3, wherein, each of the first control signals and the second control signals includes a first clock signal, a second clock signal opposite to the first clock signal in phase, a driving signal and a ground signal; each of the first scanning driving circuit and the second scanning driving circuit includes multiple scanning driving units connected sequentially; each scanning driving unit is used for outputting a corresponding scanning signal; the driving signal is inputted to the first scanning driving unit, the first clock signal is inputted to an odd-numbered scanning driving unit, the second clock signal is inputted to the even-numbered scanning driving unit, and the ground signal is inputted to each scanning driving unit.

5. The display panel according to claim 2, wherein, the display panel further includes a display screen; the first control signal unit is located directly above the display screen, the second control signal unit is located directly below the display screen, the first scanning driving circuit is located at a left side of the display screen, and the second scanning driving circuit is located at a right side of the display screen; the first scanning driving circuit and the second scanning driving circuit simultaneously provides the first scanning signal and the second scanning signal to the display screen.

6. The display panel according to claim 5, wherein, the display panel further includes four data units, each data unit includes a circuit board and a data chip located on the circuit board for generating data signals, wherein, two data units are located between the display screen and the first control signal unit for providing data signals to the display screen, the other two data units are located between the display screen and the second control signal unit for providing data signals to the display screen.

7. The display panel according to claim 2, wherein, each of the first control signal unit and the second control signal unit includes a circuit board and a control chip located on the circuit board for generating the multiple first control signals or the multiple second control signals.

8. A display device, wherein, the display device includes a display panel, and the display panel comprises:
a first control signal unit for outputting multiple first control signals;
a second control signal unit for outputting multiple second control signals, wherein the multiple first control signals and the multiple second control signals are the same; and
a first scanning driving circuit connected with the first control signal unit and the second control signal unit, and used for receiving the multiple first control signals from the first control signal unit, receiving the multiple second control signals from the second control signal unit and outputting a first scanning signal.

9. The display device according to claim 8, wherein, the display panel further includes a second scanning driving circuit is connected with the first control signal unit and the second control signal unit, and used for receiving the multiple first control signals from the first control signal unit, receiving the multiple second control signals from the second control signal unit and outputting a second scanning signal, wherein, the first scanning driving circuit and the second scanning driving circuit simultaneously output the first scanning signal and the second scanning signal according to the multiple first control signals and the multiple second control signals received from the first control signal unit and the second control signal unit.

10. The display device according to claim 9, wherein, each of the first control signals and the second control signals includes a first clock signal, a second clock signal opposite to the first clock signal in phase, a driving signal and a ground signal; each of the first scanning driving circuit and the second scanning driving circuit includes multiple scanning driving units connected sequentially; each scanning driving unit is used for outputting a corresponding scanning signal; the driving signal is inputted to the first scanning driving unit, the first clock signal is inputted to an odd-numbered scanning driving unit, the second clock signal is inputted to the even-numbered scanning driving unit, and the ground signal is inputted to each scanning driving unit.

11. The display device according to claim 8, wherein, each of the first control signal unit and the second control signal unit includes a circuit board and a control chip located on the circuit board for generating the multiple first control signals or the multiple second control signals.

12. The display device according to claim 8, wherein, the display panel further includes a display screen; the first control signal unit is located directly above the display screen, the second control signal unit is located directly below the display screen, the first scanning driving circuit is located at a left side of the display screen, and the second scanning driving circuit is located at a right side of the display screen; the first scanning driving circuit and the second scanning driving circuit simultaneously provides the first scanning signal and the second scanning signal to the display screen.

13. The display device according to claim 12, wherein, the display panel further includes four data units, each data unit includes a circuit board and a data chip located on the circuit board for generating data signals, wherein, two data units are located between the display screen and the first control signal unit for providing data signals to the display screen, the other two data units are located between the display screen and the second control signal unit for providing data signals to the display screen.
